(19) United States
(12) Patent Application Publication
(10) Pub. No.: US 2026/0136114 A1
(43) Pub. Date: May 14, 2026

(54) INFORMATION PROCESSING DEVICE AND INFORMATION PROCESSING METHOD

(71) Applicant: CANON KABUSHIKI KAISHA, Tokyo (JP)

(72) Inventors: TATSUAKI AKAHANE, Kanagawa (JP); KOKI HONDA, Kanagawa (JP)

(21) Appl. No.: 19/380,311

(22) Filed: Nov. 5, 2025

(30) Foreign Application Priority Data
Nov. 8, 2024 (JP) 2024-196042

(51) Int. Cl. H04N 25/63; G01S 7/481; G01S 7/4865; G01S 7/51; G01S 17/894

(52) U.S. Cl. CPC H04N 25/63; G01S 7/4816; G01S 7/4865; G01S 7/51; G01S 17/894

(57) ABSTRACT

A processing device includes an input unit configured to receive a signal based on an avalanche count in a light receiving element, an accumulation unit configured to accumulate a value corresponding to the avalanche count based on the signal, and a generation unit configured to generate a correction value for the signal based on the accumulated value.

### BACKGROUND

### Field of the Technology

The disclosure relates to an information processing device and an information processing method.

### Description of the Related Art

In recent years, a light receiving element capable of detecting weak light at a single photon level has been used in a wide range of fields. The light receiving element may be an APD (Avalanche Photodiode). The APD can amplify an amount of signal charge excited by a photon from several times up to one million times by avalanche multiplication generated in a strong electric field induced in a pn junction of a semiconductor. The signal-to-noise ratio can be increased by greatly amplifying the signal of weak light by utilizing the high gain characteristic of the avalanche multiplication. In photon counting using APD, the luminance of input light, which is treated as a continuous value, is counted as a discrete value which is the number of photons.

However, the characteristics of the light receiving element may change according to an accumulated value of an avalanche count. Although Japanese Patent Laid-Open No. 2008-139586 describes a method of correcting a voltage to be applied to a liquid crystal panel in accordance with a driving time, a correction in accordance with an accumulated value cannot be performed.

### SUMMARY

According to one aspect of the embodiments, there is provided a processing device including: an input unit configured to receive a signal based on an avalanche count in a light receiving element; an accumulation unit configured to accumulate a value corresponding to the avalanche count based on the signal; and a generation unit configured to generate a correction value for the signal based on the accumulated value.

According to one aspect of the embodiments, there is provided a method including: receiving a signal based on an avalanche count in a light receiving element; accumulating a value corresponding to the avalanche count based on the signal; and generating a correction value for the signal based on an accumulated value.

Features of the disclosure will become apparent from the following description of embodiments with reference to the attached drawings. The following description of embodiments is described by way of example.

### BRIEF DESCRIPTION OF THE DRAWINGS

FIG. 1 is a block diagram of an information processing system according to a first embodiment.

FIG. 2 is a block diagram of an imaging device according to the first embodiment.

FIG. 3 is a block diagram of a pixel according to the first embodiment.

FIG. 4 is a diagram illustrating a relationship between avalanche multiplication and a pulse signal according to the first embodiment.

FIG. 5 is a flowchart illustrating an operation of an information processing device according to the first embodiment.

FIG. 6 is a block diagram of an information processing device according to a second embodiment.

FIG. 7 is a diagram illustrating a relationship between a random number and a pixel value according to the second embodiment.

FIG. 8 is a flowchart illustrating a compression method according to the second embodiment.

FIG. 9 is a block diagram of an information processing device according to a third embodiment.

FIG. 10 is a diagram illustrating weighting processing according to the third embodiment.

FIG. 11 is a block diagram of an information processing device according to a fourth embodiment.

FIG. 12 is a block diagram of an information processing device according to a fifth embodiment.

FIG. 13 is a diagram illustrating a method of storing an accumulated value according to the fifth embodiment.

FIGS. 14A and 14B are diagrams illustrating a movable body according to a sixth embodiment.

FIG. 15 is a block diagram of an equipment according to a seventh embodiment.

### DESCRIPTION OF THE EMBODIMENTS

### First Embodiment

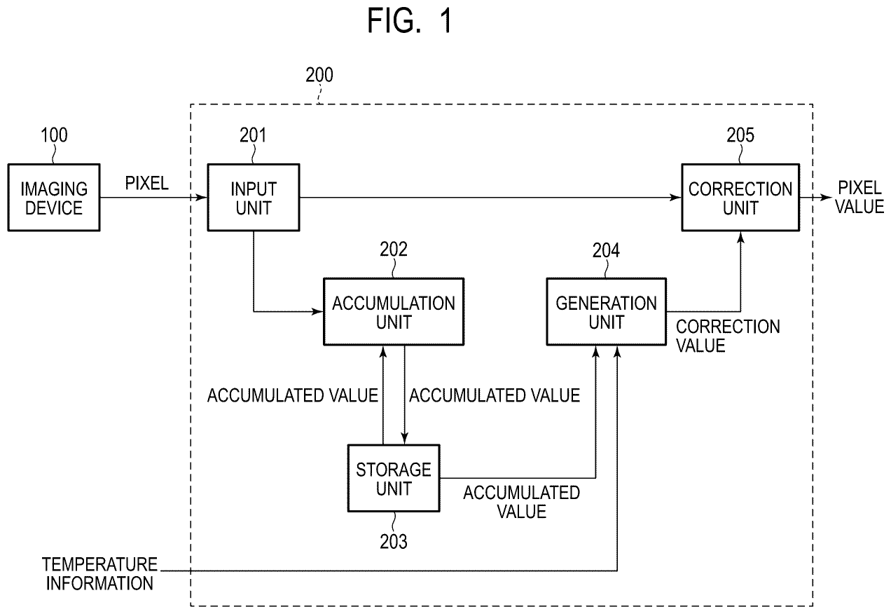

FIG. 1 is a block diagram of an information processing system according to the present embodiment. The information processing system includes an imaging device 100 and an information processing device 200. The imaging device 100 includes a plurality of pixels, and each of the plurality of pixels includes a light receiving element. The light receiving element may be an APD (Avalanche Photodiode) that amplifies an amount of signal charge excited by a photon by avalanche multiplication. The imaging device 100 detects incident light and outputs a count value (pixel value) of a pulse signal to the information processing device 200. The pixel value corresponds to the number of occurrences of the avalanche multiplication by the light receiving element (hereinafter, referred to as the avalanche count).

Although a photon is not incident on the light receiving element, the avalanche multiplication may occur. Therefore, the pixel value may include a count value that is generated by the avalanche multiplication occurring without the incidence of photons. This count value is called DCR (Dark Count Rate). The information processing device 200 estimates the DCR and corrects the pixel value obtained from the imaging device 100.

The information processing device 200 includes an input unit 201, an accumulation unit 202, a storage unit 203, a generation unit 204, and a correction unit 205.

The input unit 201 receives each pixel value of the pixels from the imaging device 100. The input unit 201 outputs the received pixel value to the accumulation unit 202 and the correction unit 205.

When the pixel value is output from the input unit 201, the accumulation unit 202 reads an accumulated value of an avalanche count for each pixel from the storage unit 203. The accumulation unit 202 updates the accumulated value of the storage unit 203 by adding the pixel value received from the input unit 201 to the accumulated value.

The storage unit 203 may be configured by a register or a RAM (Random Access Memory). The storage unit 203 stores the accumulated value of the avalanche count for each pixel.

The generation unit 204 reads the accumulated value from the storage unit 203 and estimates DCR based on the accumulated value. As the accumulated value increases, the DCR also tends to increase. Accordingly, the generation unit 204 can estimate the DCR based on the accumulated value. The generation unit 204 generates a value (hereinafter, this value is referred to as a correction value) for correcting a pixel value based on the estimated DCR. The correction value corresponds to the DCR in the pixel value. The generation unit 204 outputs the correction value to the correction unit 205.

The correction unit 205 corrects the pixel value input from the imaging device 100 based on the correction value received from the generation unit 204. Specifically, the correction unit 205 subtracts the correction value from the pixel value. Accordingly, the correction unit 205 can perform DCR correction on the pixel value. The correction unit 205 outputs the corrected pixel value to an outside of the information processing device 200.

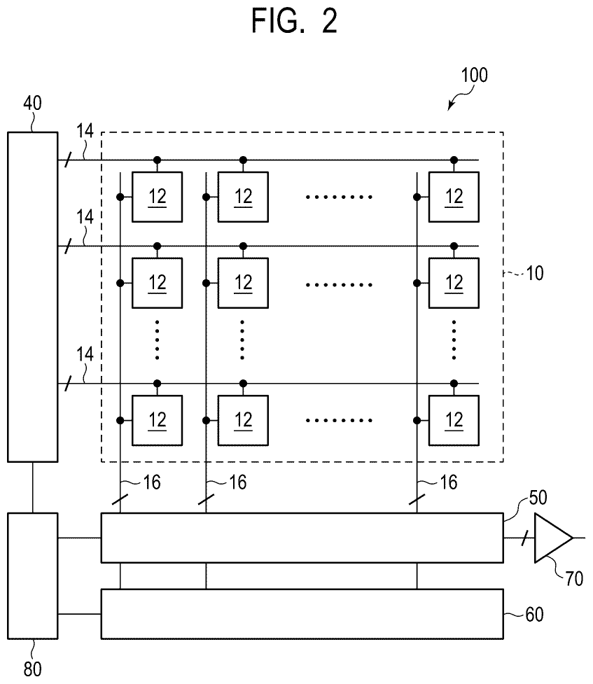

FIG. 2 is a block diagram of the imaging device 100 according to the present embodiment. The imaging device 100 includes a pixel region 10, a vertical scanning circuit unit 40, a readout circuit unit 50, a horizontal scanning circuit unit 60, an output circuit unit 70, and a control pulse generation unit 80.

A plurality of pixels 12 are provided in the pixel region 10, and the pixels 12 are arrayed to form a plurality of rows and a plurality of columns. As described later, each pixel 12 includes a photoelectric conversion unit including a light receiving element and a pixel signal processing unit that processes a signal output from the photoelectric conversion unit. The number of pixels 12 is not particularly limited. For example, the pixel region 10 can be constituted by a plurality of pixels 12 arranged in an array of several thousand rows×several thousand columns. Alternatively, the pixel region 10 may include a plurality of pixels 12 arranged in one row or one column. Alternatively, one pixel 12 may constitute the pixel region 10.

In each row of the pixel array of the pixel region 10, a control line 14 is arranged to extend in a first direction (lateral direction in FIG. 2). The control line 14 is connected to the pixels 12 arranged in the first direction and forms a signal line common to the pixels 12. Each of the control lines 14 may include a plurality of signal lines for supplying a plurality of types of control signals to the pixels 12. The control line 14 of each row is connected to the vertical scanning circuit unit 40.

In each column of the pixel array of the pixel region 10, a data line 16 is arranged to extend in a second direction (vertical direction in FIG. 2) intersecting the first direction. The data line 16 is connected to the pixels 12 arranged in the second direction and forms a signal line common to the pixels 12. Each of the data lines 16 may include a plurality of signal lines for transferring a digital signal of a plurality of bits output from the pixel 12 on a bit-by-bit basis. The data line 16 of each column is connected to the readout circuit unit 50.

The vertical scanning circuit unit 40 receives a control signal output from the control pulse generation unit 80, generates a control signal for driving the pixels 12, and supplies the control signal to the pixels 12 via the control line 14. A logic circuit such as a shift register, or an address decoder may be used as the vertical scanning circuit unit 40. The vertical scanning circuit unit 40 sequentially scans the pixels 12 in the pixel region 10 in units of rows and sequentially causes the pixels 12 to output pixel signals to the readout circuit unit 50 via the data lines 16.

The readout circuit unit 50 includes a plurality of holding units (not illustrated) provided corresponding to each column of the pixel array of the pixel region 10. The readout circuit unit 50 holds, in the holding unit of the corresponding column, the pixel signal of the pixel 12 of each column output from the pixel region 10 in units of rows via the data line 16.

The horizontal scanning circuit unit 60 receives the control signal output from the control pulse generation unit 80, generates a control signal for reading out the pixel signal from the holding unit of each column of the readout circuit unit 50, and supplies the control signal to the readout circuit unit 50. A logic circuit such as a shift register, or an address decoder may be used as the horizontal scanning circuit unit 60. The horizontal scanning circuit unit 60 sequentially scans the holding unit of each column of the readout circuit unit 50 and causes the readout circuit unit 50 to sequentially output the pixel signal held in the holding unit to the output circuit unit 70.

The output circuit unit 70 includes an external interface circuit, and outputs the pixel signal (pixel value) output from the readout circuit unit 50 to the information processing device 200.

The control pulse generation unit 80 generates control signals for controlling the operations and timings of the vertical scanning circuit unit 40, the readout circuit unit 50, and the horizontal scanning circuit unit 60, and supplies the control signal to each functional block.

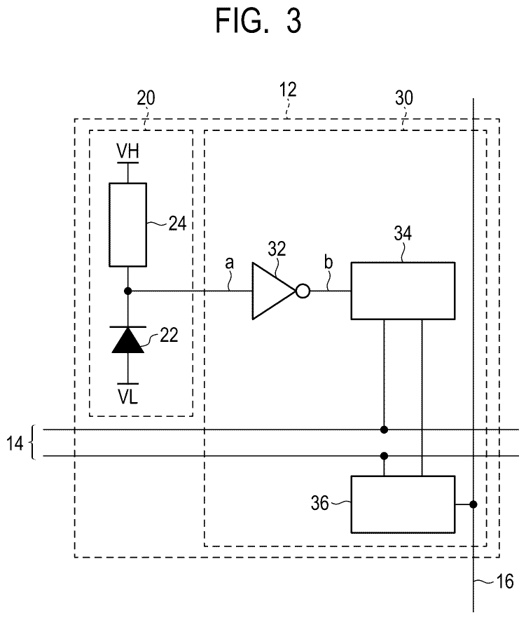

FIG. 3 is a block diagram of the pixel 12 according to the present embodiment. The pixel 12 includes a photoelectric conversion unit 20 and a pixel signal processing unit 30.

The photoelectric conversion unit 20 includes a light receiving element 22 and a quenching element 24. The pixel signal processing unit 30 includes a waveform shaping unit 32, a counter circuit 34, and a selection circuit 36.

The light receiving element 22 may be an APD as described above. An anode of the light receiving element 22 is connected to a node to which a voltage VL is supplied. A cathode of the light receiving element 22 is connected to one terminal of the quenching element 24. A connection node between the light receiving element 22 and the quenching element 24 is an output node of the photoelectric conversion unit 20. The other terminal of the quenching element 24 is connected to a node to which a voltage VH higher than the voltage VL is supplied. The voltage VL and the voltage VH are set to supply a voltage (reverse bias voltage) that induces avalanche multiplication in the light receiving element 22. Here, a negative high voltage is applied as the voltage VL, and a positive voltage comparable to a power supply voltage is applied as the voltage VH.

When the above voltage is supplied to the light receiving element 22, a charge generated by light incident on the light receiving element 22 causes the avalanche multiplication, and an avalanche current is generated. The operation modes in a state where the voltage is supplied to the light receiving element 22 include a Geiger mode and a linear mode. The Geiger mode is an operation mode in which the voltage applied between the anode and the cathode is set to a voltage higher than a breakdown voltage of the light receiving element 22. The linear mode is an operation mode in which a voltage applied between the anode and the cathode is set to a voltage close to or lower than the breakdown voltage of the light receiving element 22. The light receiving element 22 operated in the Geiger mode is called SPAD (Single Photon Avalanche Diode). The light receiving element 22 may operate in the linear mode or the Geiger mode.

The quenching element 24 converts a change in the avalanche current generated in the light receiving element 22 into a voltage signal. In addition, the quenching element 24 functions as a load circuit (quench circuit) at the time of signal multiplication by avalanche multiplication, and reduces the voltage applied to the light receiving element 22 to suppress the avalanche multiplication. The operation in which the quenching element 24 suppresses the avalanche multiplication is called a quench operation. In addition, the quenching element 24 returns the voltage supplied to the light receiving element 22 to the voltage VH by flowing a current corresponding to the voltage drop due to the quench operation. The operation of returning the voltage supplied from the quenching element 24 to the light receiving element 22 to the voltage VH is called a recharge operation. The quenching element 24 may be configured by a resistor element, a MOS transistor, or the like.

The waveform shaping unit 32 has an input node (node a) to which an output signal of the photoelectric conversion unit 20 is input and an output node (node b). The waveform shaping unit 32 converts an analog signal output from the photoelectric conversion unit 20 into a pulse signal. The waveform shaping unit 32 includes a NOT circuit (inverter circuit). The output node of the waveform shaping unit 32 is connected to the counter circuit 34.

The counter circuit 34 includes an input node to which the output signal of the waveform shaping unit 32 is input, an input node connected to the control line 14, and an output node. The counter circuit 34 counts the pulse signal superimposed on the output signal from the waveform shaping unit 32 and holds the count value. The control signal supplied from the vertical scanning circuit unit 40 to the counter circuit 34 via the control line 14 may include an enable signal for controlling a count period (exposure period) of the pulse signal, a reset signal for resetting the count value held by the counter circuit 34, and the like. The output node of the counter circuit 34 is connected to the data line 16 via the selection circuit 36.

The selection circuit 36 switches an electrical connection between the counter circuit 34 and the data line 16. The selection circuit 36 switches the connection between the counter circuit 34 and the data line 16 in accordance with a control signal supplied from the vertical scanning circuit unit 40 via the control line 14. The selection circuit 36 may include a buffer circuit (not illustrated) for outputting a signal.

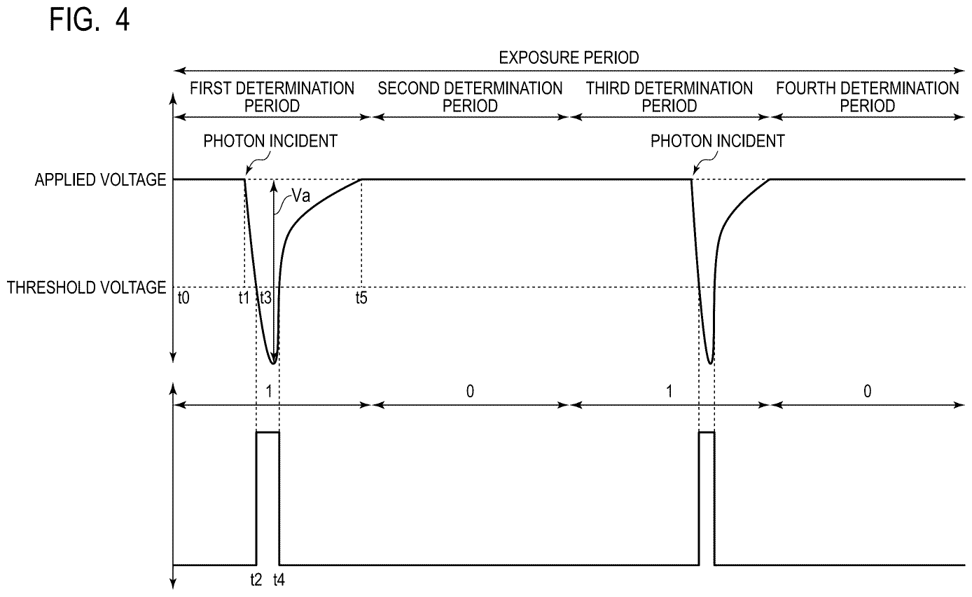

FIG. 4 is a diagram illustrating a relationship between avalanche multiplication and a pulse signal according to the present embodiment. At time t0, an applied voltage corresponding to the voltage (VH-VL) is supplied to the light receiving element 22. Although an applied voltage for inducing avalanche multiplication is supplied between the anode and the cathode of the light receiving element 22, carriers serving as a seed of the avalanche multiplication do not exist in a state where a photon is not incident on the light receiving element 22. Therefore, the avalanche multiplication does not occur in the light receiving element 22, and no current flows through the light receiving element 22.

It is assumed that a photon is incident on the light receiving element 22 at time t1. When a photon enters the light receiving element 22, an electron-hole pair is generated by photoelectric conversion. The avalanche multiplication occurs using these carriers as a seed, and an avalanche current flows through the light receiving element 22. When this avalanche current flows through the quenching element 24, a voltage drop occurs due to the quenching element 24, and the voltage of the node a of the waveform shaping unit 32 starts to drop. When the amount of voltage drop of the node a becomes large and the avalanche multiplication is stopped at time t3, the voltage of the node a no longer drops. The difference between the voltage of the node a and the applied voltage at the time t3 corresponds to a breakdown voltage Va.

When the avalanche multiplication in the light receiving element 22 is stopped, a current that compensates for the voltage drop flows from the node to which the voltage VH is supplied to the node a through the quenching element 24, and the voltage of the node a gradually increases. Thereafter, at time t5, the node a is settled to an original voltage.

The waveform shaping unit 32 binarizes the signal input from the node a according to a predetermined threshold voltage, and outputs the binarized signal from the node b. Specifically, the waveform shaping unit 32 outputs a low-level signal from the node b when the voltage of the node a exceeds the threshold voltage, and outputs a high-level signal from the node b when the voltage of the node a is equal to or less than the threshold voltage. For example, as illustrated in FIG. 4, it is assumed that the voltage of the node a is equal to or lower than the threshold voltage in the period from the time t2 to the time t4. In this case, the signal level at the node b becomes the low level in the period from the time to to the time t2 and the period from the time t4 to the time t5, and becomes the high level in the period from the time t2 to the time t4.

In this way, the analog signal input from the node a is waveform-shaped into a digital signal by the waveform shaping unit 32. A pulse signal is output from the waveform shaping unit 32 in response to incidence of a photon on the light receiving element 22.

The exposure period illustrated in FIG. 4 includes first to fourth determination periods. In each determination period, one pulse signal is generated in accordance with incident light. That is, in each determination period, even when multiple photons are incident, one pulse signal is generated.

In the first determination period and the third determination period, a photon is incident, and a pulse signal is generated, and in the second determination period and the fourth determination period, a photon is not incident and a pulse signal is not generated. Therefore, the count value of the pulse signal in the exposure period is “2”. The count value of the pulse signal can be output to the information processing device 200 for each frame period including a plurality of exposure periods.

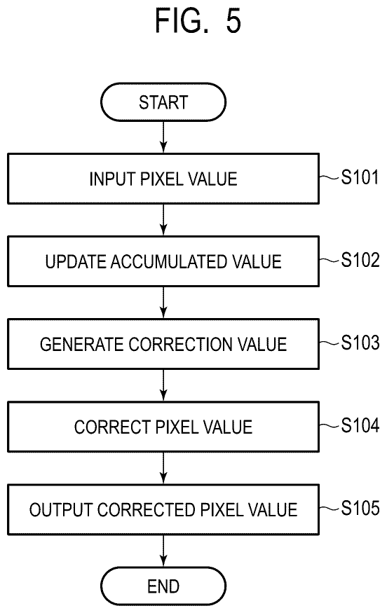

FIG. 5 is a flowchart illustrating an operation of the information processing device 200 according to the present embodiment. In step S101, the input unit 201 receives a pixel value from the imaging device 100. At this time, the input unit 201 sequentially receives the pixel value for each pixel 12. The input unit 201 outputs the pixel value received from the imaging device 100 to the accumulation unit 202 and the correction unit 205.

In step S102, when the pixel value is output from the input unit 201, the accumulation unit 202 reads an accumulated value of an avalanche count from the storage unit 203. Here, the accumulation unit 202 specifies an address of the storage unit 203 based on identification information of the pixel 12 that has output the pixel value, and reads the accumulated value. The accumulation unit 202 updates the accumulated value of the storage unit 203 by adding the pixel value obtained from the imaging device 100 to the accumulated value.

In step S103, the generation unit 204 generates a correction value based on the accumulated value. It has been confirmed by experiments that DCR increases logarithmically rather than linearly proportional to the accumulated value. Therefore, the generation unit 204 can generate the correction value D by the following formula (1).

$$D = α * log ( 1 + β * B ) + {D}_{0} \qquad ( 1 )$$

α and β are constants, D₀ is an initial correction value, and β is an accumulated value. α, β, and D₀ are obtained based on experiments. The generation unit 204 outputs the calculated correction value D to the correction unit 205.

In step S104, the correction unit 205 corrects the pixel value obtained from the imaging device 100 based on the correction value D received from the generation unit 204. Specifically, as illustrated in the following formula (2), the correction unit 205 subtracts the correction value D from the pixel value B to obtain a corrected pixel value B′.

$${B}^{′} = B - D \qquad ( 2 )$$

In step S105, the correction unit 205 outputs the corrected pixel value B′ to an outside of the information processing device 200.

As described above, according to the information processing device 200, an accurate correction value of the DCR can be provided based on the accumulated value of the avalanche counts, and the pixel value from the imaging device 100 can be corrected based on the correction value. Accordingly, the information processing device 200 can output a pixel value in which DCR is suppressed.

An information processing method according to the present embodiment, a program for causing a computer to execute the information processing method, and a non-transitory computer-readable storage medium storing the program have the same effects as those of the information processing device 200.

The formula for generating the correction value D is not limited to the formula (1), and other formulas may be used as long as they are based on the accumulated value of the avalanche count.

In addition, considering that DCR is affected by temperature, the generation unit 204 may generate the correction value D based on the temperature information of the light receiving element 22 in addition to the accumulated value. For example, the correction value D can be generated by adding a term or a coefficient related to the temperature information of the light receiving element 22 to the formula (1).

The input unit 201 may adjust the timing of outputting the pixel value. Specifically, the input unit 201 may delay the timing of outputting the pixel value to the correction unit 205 relative to the timing of outputting the pixel value to the accumulation unit 202. Accordingly, in the correction unit 205, the timing of receiving the pixel value and the timing of receiving the correction value can be matched, and the correction processing can be smoothly performed.

### Second Embodiment

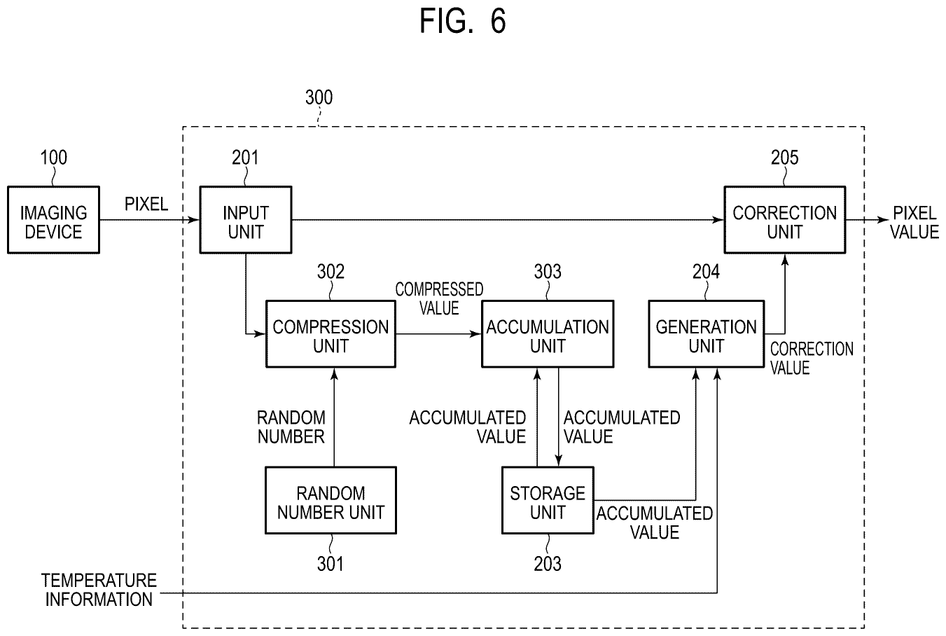

FIG. 6 is a block diagram of an information processing device 300 according to the present embodiment. The information processing device 300 is different from the information processing device 200 according to the first embodiment in that an accumulated value is compressed using a random number. In the present embodiment, the same components as those of the information processing device 200 according to the first embodiment are denoted by the same reference numerals, and detailed description thereof will be omitted.

The information processing device 300 includes an input unit 201, a storage unit 203, a generation unit 204, a correction unit 205, a random number unit 301, a compression unit 302, and an accumulation unit 303.

The random number unit 301 generates a random number using a predetermined random number generation algorithm. Here, a lower limit value of the random number is set to 0, and an upper limit value of the random number is set based on the maximum value of the pixel value. The upper limit value of the random number is, for example, 1000 times the maximum value of the pixel value. Here, when the maximum value of the pixel values is 2047, the upper limit value of the random number is 2047000, and the accumulated value is compressed to 1/2047000. The upper limit value of the random number is not limited to this value and may be set to an upper limit value corresponding to a desired compression ratio.

When the pixel value is output from the input unit 201, the compression unit 302 compresses the pixel value based on the random number received from the random number unit 301, and outputs the compressed pixel value (hereinafter, this is referred to as a compressed value) to the accumulation unit 303.

When the compressed value is output from the compression unit 302, the accumulation unit 303 reads the accumulated value from the storage unit 203. The accumulation unit 303 updates the accumulated value of the storage unit 203 by adding the compressed value received from the compression unit 302 to the accumulated value.

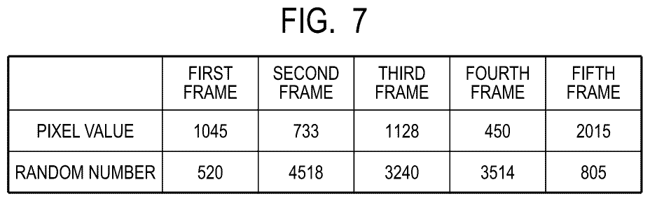

FIG. 7 is a diagram illustrating a relationship between a random number and a pixel value according to the present embodiment. FIG. 7 illustrates a relationship between a random number and a pixel value for each frame output from the imaging device 100. The pixel value in FIG. 7 indicates one of a plurality of pixel values included in the frame.

The compression unit 302 compares the pixel value “1045” with the random number “520” in the first frame. Since the pixel value is larger than the random number, the compression unit 302 converts the pixel value into “1” (first value). The compressed value does not necessarily need to be “1” and in one embodiment, is smaller than the pixel value.

In the second frame, since the pixel value “733” is equal to or less than the random number “4518”, the compression unit 302 converts the pixel value into “0” (second value). Similarly, the pixel values of the third to fifth frames are converted into “0”, “O”, and “1”.

Here, when the pixel values of the first to fifth frames are not compressed, the accumulated value is “5371” (=1045+733+1128+450+2015). On the other hand, according to the present embodiment, since the accumulated value is compressed from “5371” to “2” (=1+0+0+0+1), the storage capacity of the storage unit 203 can be reduced.

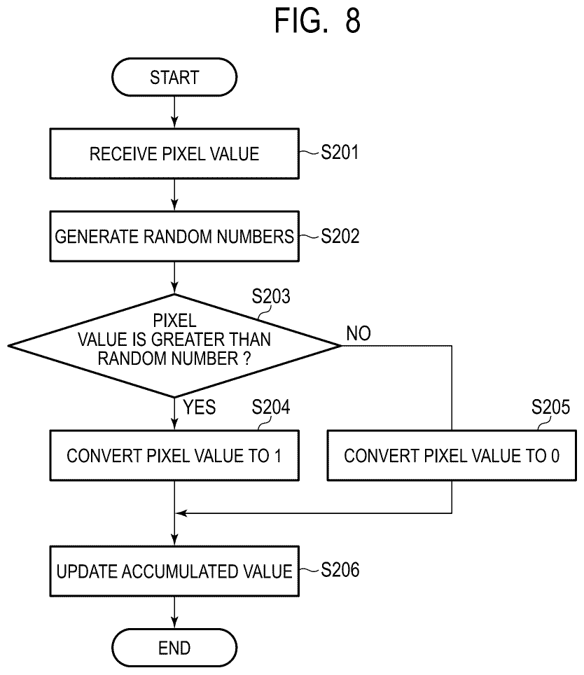

FIG. 8 is a flowchart illustrating a compression method according to the present embodiment. In step S201, the compression unit 302 receives a pixel value obtained from the imaging device 100.

In step S202, the random number unit 301 generates a random number. In step S203, the compression unit 302 compares the pixel value with the random number. When the pixel value is larger than the random number (step S203; YES), in step S204, the compression unit 302 compresses the pixel value by converting the pixel value to “1”.

When the pixel value is equal to or less than the random number (step S203; NO), in step S205, the compression unit 302 compresses the pixel value by converting the pixel value to “0”.

In step S206, the accumulation unit 303 updates the accumulated value in the storage unit 203 by adding the compressed value received from the compression unit 302 to the accumulated value.

As described above, according to the information processing device 300, since the accumulated value can be compressed, the storage capacity of the storage unit 203 can be reduced.

When the generation unit 204 calculates the correction value D using the above formula (1), α and β may be adjusted according to the compression ratio.

As another compression method, the accumulation unit 303 may accumulate pixel values obtained from the imaging device 100 every multiple frames. For example, when pixel values are accumulated every 1000 frames, the accumulated value is compressed to 1/1000. Alternatively, the compression method using the random number may be combined with the compression method of accumulating pixel values every multiple frames. That is, the compression of the bit length of the pixel value may be combined with the compression of the time axis (accumulated frequency). Accordingly, the accumulated value can be compressed at a higher compression rate, and the storage capacity of the storage unit 203 can be further reduced.

### Third Embodiment

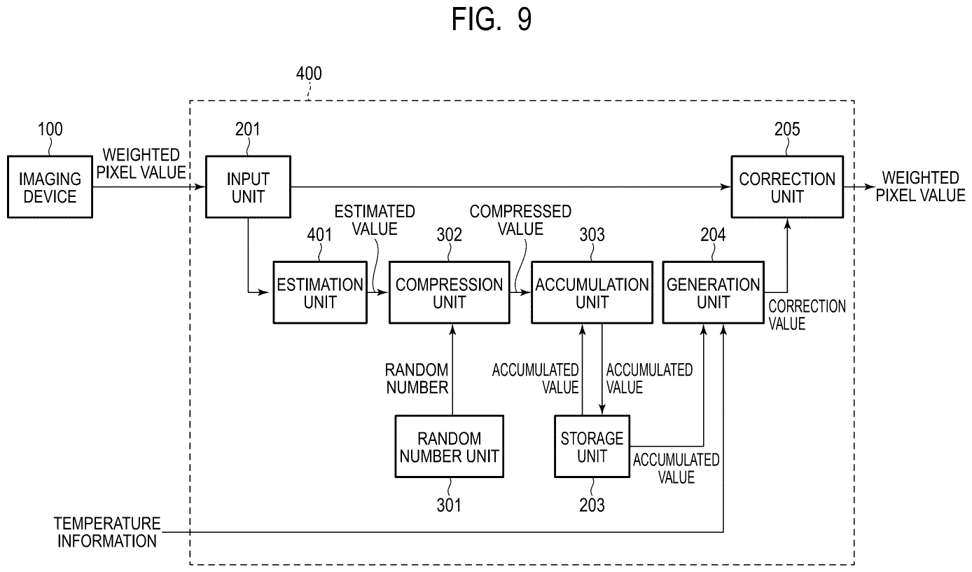

FIG. 9 is a block diagram of the information processing device 400 according to the present embodiment. The information processing device 400 is different from the information processing device 300 according to the second embodiment in that a pixel value that is not weighted is estimated from a weighted pixel value. In the present embodiment, the same components as those of the information processing device 300 according to the second embodiment are denoted by the same reference numerals, and detailed description thereof will be omitted.

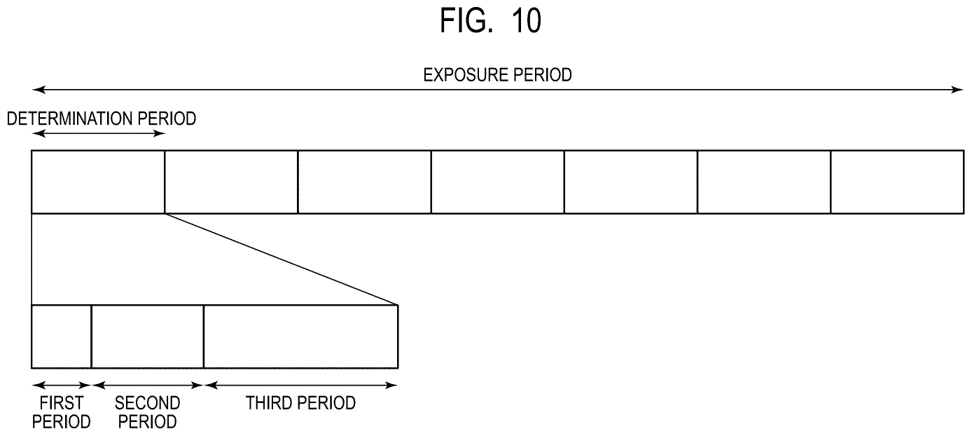

FIG. 10 is a diagram illustrating weighting processing according to the present embodiment. The exposure period includes a plurality of determination periods. Each of the determination periods is divided into a first period, a second period, and a third period. The first to third periods are examples of divided periods. In each of the first to third periods, a value for counting up the pulse signal is different. That is, weighting is set. A higher weighting is set at an earlier timing in the first to third periods. Here, the timing is earlier in the order of the first period, the second period, and the third period. Therefore, the weight of the first period is the highest, the weight of the second period is the next highest, and the weight of the third period is the lowest. Since the influence of the so-called after-pulse is suppressed by the weighting, it is possible to suppress a decrease in the SN ratio.

When the pulse signal is detected in the first period, the counter circuit 34 of the pixel 12 counts up the avalanche count three times. When the pulse signal is detected in the second period, the counter circuit 34 counts up the avalanche count twice. When the pulse signal is detected in the third period, the counter circuit 34 counts up the avalanche count by one. Thus, the weighting value in the first period is “3”, the weighting value in the second period is “2”, and the weighting value in the third period is “1”. When the pulse signal is not detected in the first to third periods, the counter circuit 34 does not count up the avalanche count. The counter circuit 34 sums up the count values in the determination periods and sets the sum as the count value of the exposure period. The imaging device 100 outputs a count value (weighted pixel value) to the information processing device 400 for each frame period including a plurality of exposure periods. Note that the number of divisions and the weighting value in the determination period are merely examples and are not limited thereto.

Ba is the avalanche count (pixel value) generated in the light receiving element 22, and Oₚ is the weighted pixel value. Here, the pixel value is not weighted and is a value obtained by counting up the avalanche count by one time every time a pulse signal is detected. The relationship between the pixel value and the weighted pixel value is expressed by the following formula (3).

$${O}_{p} = f ( {B}_{a} ) \qquad ( 3 )$$

The inverse transformation of the formula (3) is represented by the following formula (4). The pixel value Ba can be obtained from formula (4).

$${B}_{a} = {f}^{- 1} ( {O}_{p} ) \qquad ( 4 )$$

In a case where the inverse function f⁻¹ is not obtained, the pixel value can be obtained from the weighted pixel value based on an approximate calculation or an experimental correspondence relationship.

A specific method of estimating a pixel value from the weighted pixel value based on the relationship in formula (4) will be described using formulas (5) to (7).

$$p = P / N / M \qquad ( 5 )$$

In formula (5), Nis the number of determination periods in the exposure period, P is the number of photons in the exposure period, and M is the maximum value of the weighting value. Here, N is 7 and M is 3. The occurrence probability p of avalanche multiplication in the first to third periods is obtained by the above formula (5).

$$d [ i ] = \{ \begin{matrix}0 ( i = 0 ) \\ 1 - exp ( - p * th [ i ] ) ( 1 \leq i \leq m )\end{matrix} \qquad ( 6 )$$

In formula (6), m is the number obtained by dividing the determination period, th[i] is a weighting value in each of the first to third periods, i is an integer of 1 or more and m or less, and p is an occurrence probability of the avalanche multiplication obtained in formula (5). Here, m is 3, the weighting value th[1] of the first period is 3, the weighting value th[2] of the second period is 2, and the weighting value th[3] of the third period is 1. The occurrence probability d[i] of the avalanche multiplication in consideration of the weighting values of the first to third periods is obtained by the above formula (6).

$$A = N * {\sum }_{i = 1}^{m} \{ ( d [ i ] + 1 - d [ i ] ) * ( ( m - i ) * d [ m ] + 1 ) \} \qquad ( 7 )$$

In formula (7), the estimated value A is obtained using the number N of determination periods in the exposure period and the occurrence probability d[i] of the avalanche multiplication obtained in formula (6). The estimated value A is obtained by estimating the pixel value from the weighted pixel value.

As illustrated in FIG. 9, the information processing device 400 includes an input unit 201, a storage unit 203, a generation unit 204, a correction unit 205, a random number unit 301, a compression unit 302, an accumulation unit 303, and an estimation unit 401.

The input unit 201 receives the weighted pixel value from the imaging device 100. The input unit 201 outputs the received weighted pixel value to the estimation unit 401 and the correction unit 205.

The estimation unit 401 obtains the estimated value A from the weighted pixel value using the above formula (7), and outputs the estimated value A to the compression unit 302.

The compression unit 302 compresses the estimated value A based on a random number received from the random number unit 301, and outputs the compressed estimated value A (hereinafter, this value A is referred to as a compressed value) to the accumulation unit 303. The accumulation unit 303 updates the accumulated value of the storage unit 203 by adding the compressed value to the accumulated value.

The generation unit 204 estimates DCR based on the accumulated value read from the storage unit 203. The generation unit 204 generates a correction value for the weighted pixel value based on the estimated DCR and outputs the correction value to the correction unit 205.

The correction unit 205 corrects the weighted pixel value obtained from the imaging device 100 based on the correction value received from the generation unit 204. Specifically, the correction unit 205 subtracts the correction value from the weighted pixel value.

As described above, the information processing device 400 includes the estimation unit 401 that estimates the pixel value from the weighted pixel value weighted according to the timing at which the pulse signal based on the avalanche multiplication by the light receiving element 22 is detected within the exposure period. Then, by obtaining the correction value based on the accumulated value of the estimated pixel values, the weighted pixel value obtained from the imaging device 100 can be corrected based on the correction value. Accordingly, the information processing device 400 can output the weighted pixel value in which the DCR is suppressed.

The estimated value may not be necessarily compressed. In case of not compressing the estimated value, the estimation unit 401 outputs the estimated value to the accumulation unit 303, and the accumulation unit 303 updates the accumulated value of the storage unit 203 by adding the estimated value to the accumulated value.

### Fourth Embodiment

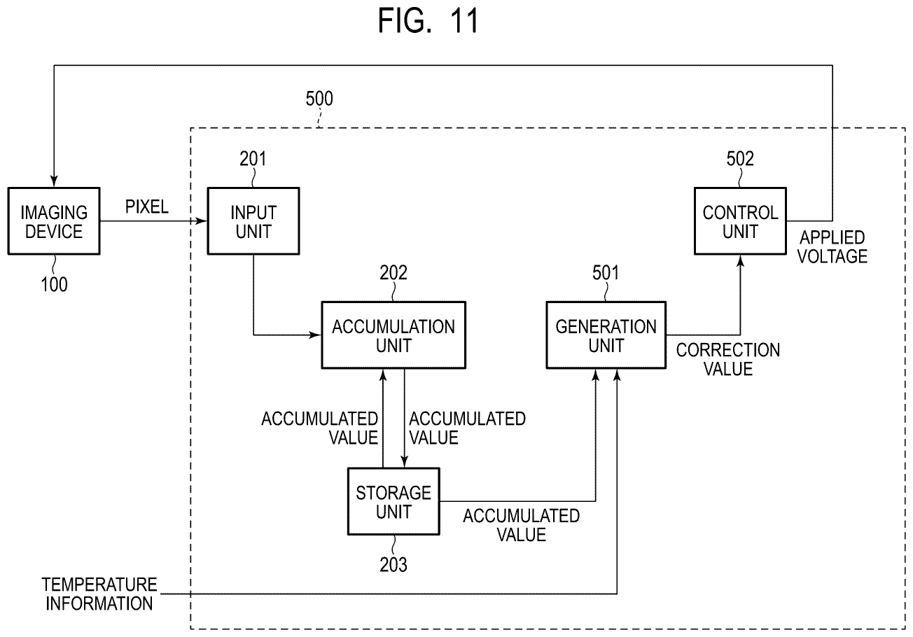

FIG. 11 is a block diagram of the information processing device 500 according to the present embodiment. The information processing device 500 is different from the information processing device 200 according to the first embodiment in that an applied voltage to the light receiving element 22 is corrected. In the present embodiment, the same components as those of the information processing device 200 according to the first embodiment are denoted by the same reference numerals, and detailed description thereof will be omitted.

The information processing device 500 includes an input unit 201, an accumulation unit 202, a storage unit 203, a generation unit 501, and a control unit (correction unit) 502.

The generation unit 501 estimates breakdown voltage of the light receiving element 22 based on an accumulated value read from the storage unit 203. As the accumulated value of avalanche counts increases, the breakdown voltage of the light receiving element 22 also tends to increase. The generation unit 501 estimates the breakdown voltage based on the accumulated value and generates a correction value for the voltage applied to the light receiving element 22 based on the estimated breakdown voltage. It has been confirmed by experiments that the breakdown voltage increases logarithmically. That is, the rate of increase in breakdown voltage tends to decrease as the accumulated value increases. The generation unit 204 generates the correction value ΔV by the following formula (8) based on this tendency.

$$Δ V = γ * log ( 1 + δ * B ) + {D}_{0} \qquad ( 8 )$$

γ and δ are constants, D₀ is an initial correction value, and β is an accumulated value. γ, δ, and D₀ are obtained based on experiments. The generation unit 501 outputs the correction value ΔV to the control unit 502.

The control unit 502 corrects the voltage applied to the light receiving element 22 based on the correction value ΔV received from the generation unit 501. Specifically, as illustrated in the following formula (9), the control unit 502 obtains the corrected applied voltage V′ by adding the correction value ΔV to the uncorrected applied voltage V.

$${V}^{′} = V + Δ V \qquad ( 9 )$$

The control unit 502 outputs voltage information indicating the applied voltage V′ to the imaging device 100. The imaging device 100 controls the applied voltage supplied to the light receiving element 22 based on the voltage information received from the control unit 502.

As described above, according to the information processing device 500, the correction value of the applied voltage can be provided based on the accumulated value of the avalanche count, and the applied voltage of the light receiving element 22 can be corrected based on the correction value. By correcting the applied voltage in accordance with the accumulated value of the avalanche count, the information processing device 500 can reduce the temporal change in the pixel value.

### Fifth Embodiment

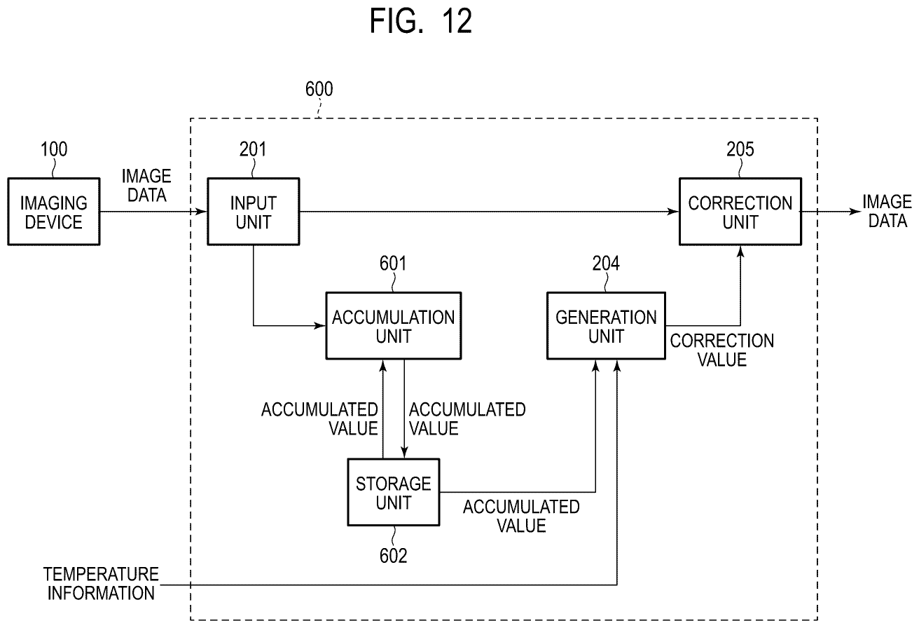

FIG. 12 is a block diagram of the information processing device 600 according to the present embodiment. The information processing device 600 is different from the information processing device 200 according to the first embodiment in that image data including a plurality of pixel values is input instead of sequentially inputting a pixel value for each pixel 12. In the present embodiment, the same components as those of the information processing device 200 according to the first embodiment are denoted by the same reference numerals, and detailed description thereof will be omitted.

The imaging device 100 outputs image data including a plurality of pixel values to the information processing device 600. The plurality of pixel values in the image data are stored in association with XY coordinates, and the pixel values are specified by specifying the XY coordinates.

The information processing device 600 includes an input unit 201, a generation unit 204, a correction unit 205, an accumulation unit 601, and a storage unit 602.

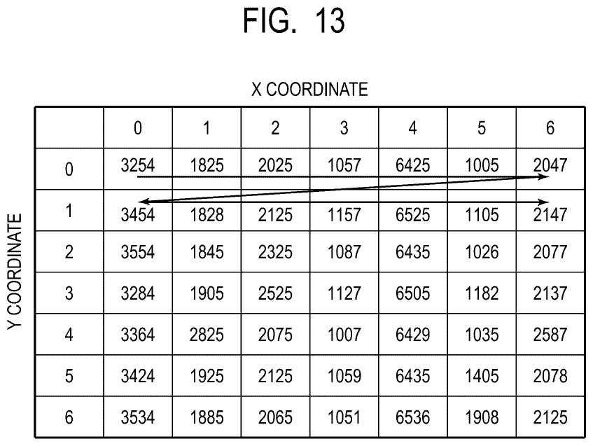

FIG. 13 is a diagram illustrating a method of storing an accumulated value according to the present embodiment. The storage unit 602 stores a plurality of accumulated values in association with the pixel array of the pixel region 10. When the first direction and the second direction of the pixel region 10 are assigned to the coordinates (x, y), for example, the storage unit 602 stores the accumulated value “3254” in association with the coordinates (0, 0) and stores the accumulated value “1825” in association with the coordinates (1, 0).

The input unit 201 receives image data from the imaging device 100. The input unit 201 outputs the received image data to the accumulation unit 601 and the correction unit 205.

When the image data is output from the input unit 201, the accumulation unit 601 reads the accumulated values from the storage unit 602 in a predetermined order. Specifically, the accumulation unit 601 reads the accumulated values in the order of coordinates (0, 0), (1, 0), . . . , (6, 0), (0, 1), (1, 1), . . . , (6, 1), as indicated by arrows in FIG. 13. Thus, the accumulation unit 601 can read the accumulated value corresponding to each of the pixel values in the image data. The accumulation unit 601 updates the accumulated value of the storage unit 602 by adding the pixel value to the accumulated value. The accumulation unit 202 performs the same processing on all the pixel values included in the image data.

The generation unit 204 reads the accumulated values from the storage unit 602 in a predetermined order. Specifically, the generation unit 204 reads the accumulated values in the order of coordinates (0, 0), (1, 0), . . . , (6, 0), (0, 1), (1, 1), . . . , as indicated by arrows in FIG. 13. Thus, the generation unit 204 can read the accumulated value corresponding to each of the plurality of pixel values in the image data. The generation unit 204 estimates DCR based on the accumulated value. The generation unit 204 generates a correction value based on the estimated DCR. In this way, the generation unit 204 generates the correction values corresponding to all the pixel values in the image data. The generation unit 204 outputs the generated correction values to the correction unit 205.

When the image data is output from the imaging device 100, the correction unit 205 reads the correction values in a predetermined order. Thus, the correction unit 205 can read the correction value corresponding to each of the pixel values in the image data. The correction unit 205 corrects the pixel value based on the read correction value. The correction unit 205 corrects all pixel values included in the image data.

As described above, the information processing device 600 can provide image data in which DCR is suppressed.

The constituent elements of the information processing devices 200 to 600 may be combined as appropriate. For example, the random number unit 301 and the compression unit 302 may be combined with the information processing device 500 or 600 to compress the accumulated value. The estimation unit 401 may be combined with the information processing device 500 or 600 to process the weighted pixel values.

### Sixth Embodiment

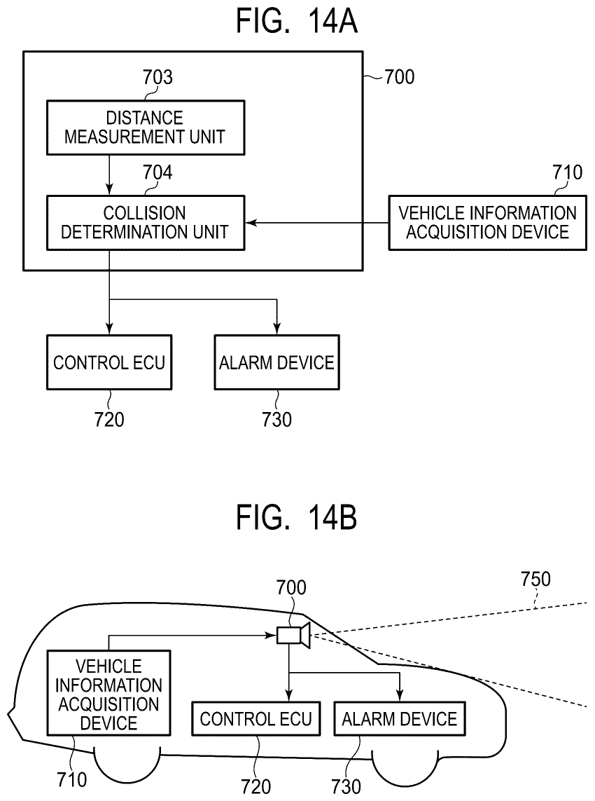

FIGS. 14A and 14B are diagrams illustrating a movable body according to the present embodiment. FIG. 14A illustrates a configuration example of an equipment 700 mounted on a vehicle as an in-vehicle camera. The equipment 700 includes a distance measurement unit 703 that measures a distance to an object, and a collision determination unit 704 that determines whether there is a collision possibility based on the distance measured by the distance measurement unit 703. The distance measurement unit 703 includes a light source device having a light emitting element that emits light, and a light receiving device having a light receiving element that receives light emitted from the light source device and reflected by the measurement target. The distance measurement unit 703 further includes the information processing device according to any of the first to fifth embodiments that processes a signal from the light receiving device, and a distance information acquisition unit. The distance information acquisition unit acquires information on a distance to the object based on a time difference between a timing at which the light is emitted from the light emitting element and a timing at which the light receiving element receives the light emitted from the light emitting element and reflected by the object.

The equipment 700 is connected to a vehicle information acquisition device 710 and can acquire vehicle information such as a vehicle speed, a yaw rate, and a steering angle. In addition, a control ECU 720 is connected to the equipment 700, the control ECU 720 is a control device that outputs a control signal for generating a braking force to the vehicle based on the determination result of the collision determination unit 704. The equipment 700 is also connected to an alarm device 730 that issues an alarm to the driver based on the determination result of the collision determination unit 704. For example, when the determination result of the collision determination unit 704 indicates that the possibility of collision is high, the control ECU 720 performs vehicle control to avoid collision and reduce damage by, for example, applying a brake, returning an accelerator, or suppressing engine output. The alarm device 730 gives an alarm to the user by sounding an alarm such as a sound, displaying alarm information on a screen of a car navigation system or the like, giving vibration to a seat belt or a steering wheel, or the like. These devices of the equipment 700 function as a movable body controller that controls the operation of controlling the vehicle as described above.

In the present embodiment, the distance to the surroundings of the vehicle, for example, the front or the rear is measured by the equipment 700. FIG. 14B illustrates an equipment in the case of distance measurement in front of the vehicle (distance measurement range 750). The vehicle information acquisition device 710 serving as the distance measurement control unit sends an instruction to the equipment 700 or the distance measurement unit 703 to perform the distance measurement operation. With such a configuration, the accuracy of distance measurement can be further improved.

In the above description, an example in which control is performed so as not to collide with another vehicle has been described, but the present embodiment is also applicable to control in which automatic driving is performed to follow another vehicle, control in which automatic driving is performed so as not to protrude from a lane, and the like. Furthermore, the equipment is not limited to vehicles such as automobiles, and can be applied to, for example, ships, aircrafts, artificial satellites, industrial robots, consumer robots, and the like movable body (moving devices). In addition, the present embodiment is not limited to movable body and can be widely applied to devices utilizing object recognition or biological recognition, such as an intelligent traffic system (ITS) and a monitoring system.

### Seventh Embodiment

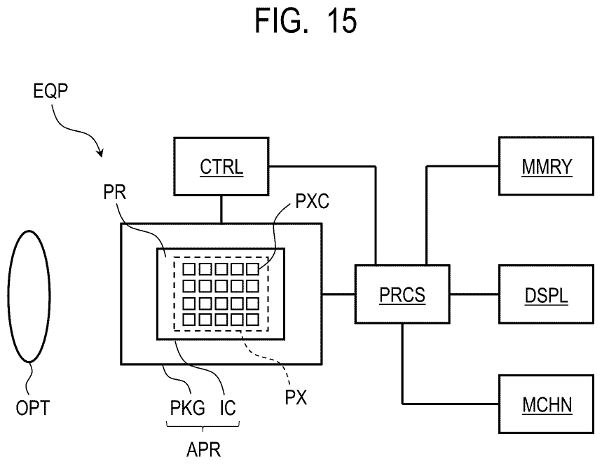

FIG. 15 is a block diagram of an equipment EQP according to the present embodiment. The equipment EQP includes a light source device having a light emitting element that emits light, and a photoelectric conversion device APR having a light receiving element that receives light emitted from the light emitting element of the light source device and reflected by an object and converting an optical signal into an electrical signal. All or part of the photoelectric conversion device APR is a semiconductor device IC. The photoelectric conversion device APR can be used as, for example, an image sensor, an AF (Auto Focus) sensor, a photometric sensor, or a distance measuring sensor. The semiconductor device IC has a pixel area PX in which pixel circuits PXC including photoelectric conversion units are arranged in a matrix. The semiconductor device IC may have a peripheral area PR around the pixel area PX. A circuit other than the pixel circuit can be disposed in the peripheral area PR.

The photoelectric conversion device APR may have a structure (chip stacked structure) in which a first semiconductor chip provided with a plurality of photoelectric conversion units and a second semiconductor chip provided with a peripheral circuit are stacked. Each of the peripheral circuits in the second semiconductor chip may be a column circuit corresponding to a pixel column of the first semiconductor chip. The peripheral circuits in the second semiconductor chip may be matrix circuits corresponding to pixels or pixel blocks in the first semiconductor chip. A through electrode (TSV), an inter-chip wiring by direct bonding of a conductor such as copper, a connection by a micro bump between chips, a connection by wire bonding, or the like can be applied in the connection between the first semiconductor chip and the second semiconductor chip.

The photoelectric conversion device APR may include a package PKG that accommodates the semiconductor device IC in addition to the semiconductor device IC. The package PKG may include a base to which the semiconductor device IC is fixed, a lid such as glass facing the semiconductor device IC, and a connection member such as a bonding wire or a bump for connecting a terminal provided in the base and a terminal provided in the semiconductor device IC.

The equipment EQP may further include at least one of an optical device OPT, a control device CTRL, a processing device PRCS, a display device DSPL, a storage device MMRY, and a mechanical device MCHN. The optical device OPT corresponds to the photoelectric conversion device APR and is, for example, a lens, a shutter, or a mirror. The control device CTRL controls the photoelectric conversion device APR, and is, for example, a semiconductor device such as an ASIC. The processing device PRCS processes a signal output from the photoelectric conversion device APR and is a semiconductor device such as a central processing unit (CPU) or an application specific integrated circuit (ASIC). The processing device PRCS includes the information processing device according to any of the first to fifth embodiments. The display device DSPL is an EL display device or a liquid crystal display device that displays information (image) obtained by the photoelectric conversion device APR. The storage device MMRY is a magnetic device or a semiconductor device that stores information (image) obtained by the photoelectric conversion device APR. The storage device MMRY is a volatile memory such as an SRAM or a DRAM, or a nonvolatile memory such as a flash memory or a hard disk drive. The mechanical device MCHN includes a movable portion or a propulsion portion such as a motor or an engine. In the equipment EQP, a signal output from the photoelectric conversion device APR is displayed on the display device DSPL or transmitted to the outside by a communication device (not illustrated) included in the equipment EQP. Therefore, in one embodiment, the equipment EQP further include a storage device MMRY and a processing device PRCS separately from the storage circuit unit and the arithmetic circuit unit included in the photoelectric conversion device APR.

The equipment EQP illustrated in FIG. 15 may be an electronic device such as an information terminal (for example, a smartphone or a wearable terminal) or a camera (for example, an interchangeable lens camera, a compact camera, a video camera, and a monitoring camera.) including a photographing function. The mechanical device MCHN in the camera can drive components of the optical device OPT for zooming, focusing, and shutter operation. The equipment EQP may be a transportation device (movable body) such as a vehicle or a ship. The equipment EQP may be a medical device such as an endoscope or a CT scanner.

The mechanical device MCHN in the transport device can be used as a mobile device. The equipment EQP as a transport device is suitable for transporting the photoelectric conversion device APR and assisting and/or automating operation (manipulation) by an imaging function. The processing device PRCS for assisting and/or automating operation (manipulation) can perform processing for operating the mechanical device MCHN as a moving device based on information obtained by the photoelectric conversion device APR.

The photoelectric conversion device APR according to the present embodiment can provide a high value to a designer, a manufacturer, a seller, a purchaser, and/or a user thereof. Therefore, when the photoelectric conversion device APR is mounted on the equipment EQP, the value of the equipment EQP can also be increased. Therefore, in manufacturing and selling the equipment EQP, it is advantageous to determine the mounting of the photoelectric conversion device APR of the present embodiment on the equipment EQP to increase the value of the equipment EQP.

### Modified Embodiments

The present disclosure is not limited to the above embodiment, and various modifications are possible. For example, an example in which a part of the configuration of any of the embodiments is added to another embodiment or an example in which a part of the configuration of another embodiment is replaced with another embodiment is also an embodiment of the present disclosure.

In the above description, an example in which the DCR correction and the correction of the applied voltage are performed based on the accumulated value of the avalanche count has been described, but the present embodiment is not limited thereto, and for example, the defect correction of the pixel and the determination of the use period of the light receiving element may be performed.

According to the present disclosure, it is possible to realize an information processing device and an information processing method capable of providing an accurate correction value.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-196042, filed Nov. 8, 2024, which is hereby incorporated by reference herein in its entirety.

What is claimed is:

1. A processing device comprising:
an input unit configured to receive a signal based on an avalanche count in a light receiving element;
an accumulation unit configured to accumulate a value corresponding to the avalanche count based on the signal; and
a generation unit configured to generate a correction value for the signal based on the accumulated value.

2. The processing device according to claim 1, further comprising a correction unit configured to correct the signal based on the correction value.

3. The processing device according to claim 2,
wherein the correction value corresponds to a dark count rate of the signal, and
wherein the correction unit subtracts the correction value from the signal.

4. The processing device according to claim 3, wherein the correction value (D) is calculated as follows:
$$D = α * log ( 1 + β * B ) + {D}_{0}$$
where B is the avalanche count, α and β are constants, and D₀ is an initial correction value.

5. The processing device according to claim 1, further comprising a compression unit configured to compress the avalanche count,
wherein the accumulation unit accumulates a compressed value of the avalanche count.

6. The processing device according to claim 5, wherein the compression unit compresses the avalanche count based on a random number.

7. The processing device according to claim 6, wherein the compression unit converts the avalanche count into a first value smaller than the avalanche count in a case where the avalanche count is larger than the random number and converts the avalanche count into a second value smaller than the first value in a case where the avalanche count is equal to or smaller than the random number.

8. The processing device according to claim 7, wherein the first value is 1, the second value is 0.

9. The processing device according to claim 1, wherein the accumulation unit accumulates the avalanche count every multiple frames.

10. The processing device according to claim 1, further comprising an estimation unit configured to estimate the avalanche count based on the signal weighted according to a timing at which a pulse signal according to avalanche multiplication by the light receiving element is detected within an exposure period,
wherein the accumulation unit accumulates an estimated value according to the estimated avalanche count.

11. The processing device according to claim 10,
wherein the exposure period includes a plurality of determination periods, each of the determination periods includes a plurality of divided periods, and
wherein the estimated value (A) is calculated as follows:
$$d [ i ] = \{ \begin{matrix}0 ( i = 0 ) \\ 1 - exp ( - p * th [ i ] ) ( 1 \leq i \leq m )\end{matrix}$$
$$A = N * {\sum }_{i = 1}^{m} \{ ( d [ i ] + 1 - d [ i ] ) * ( ( m - i ) * d [ m ] + 1 ) \}$$
where m is the number of the divided periods, th[i] is a weighting value, i is an integer of 1 or more and m or less, p is an occurrence probability of avalanche multiplication in the divided periods, d[i] is an occurrence probability of avalanche multiplication in consideration of the weighting value in each of the divided periods, and N is the number of the determination periods.

12. The processing device according to claim 2, wherein the correction unit corrects an applied voltage to the light receiving element based on the correction value.

13. The processing device according to claim 12, wherein the correction value (ΔV) is calculated as follows:
$$Δ V = γ * log ( 1 + δ * B ) + {D}_{0}$$
where B is the avalanche count, γ and δ are constants, and D₀ is an initial correction value.

14. The processing device according to claim 1,
wherein a plurality of light receiving elements are arranged in an array, and
wherein the accumulation unit holds the accumulated value for each of the plurality of light receiving elements.

15. The processing device according to claim 1, wherein the generation unit generates the correction value based on temperature information of the light receiving element and the accumulated value.

16. A ranging device comprising:
a light source device configured to emit light;
a light receiving device including the light receiving element according to claim 1, wherein the light receiving element is configured to receive light emitted from the light source device and reflected by an object to be measured;
the processing device according to claim 1 configured to process a signal from the light receiving device; and
an acquisition unit configured to acquire information on a distance to the object to be measured based on a time difference between a timing at which light is emitted from the light source device and a timing at which the light receiving device receives light.

17. An equipment comprising:
a photoelectric conversion device configured to include the light receiving element according to claim 1 and convert an optical signal into an electrical signal;
the processing device according to claim 1 configured to process a signal output from the photoelectric conversion device; and
at least one of:
an optical device corresponding to the photoelectric conversion device;
a control device configured to control the photoelectric conversion device;
a mechanical device configured to be controlled based on information obtained by the photoelectric conversion device;
a display device configured to display information obtained by the photoelectric conversion device; and
a storage device configured to store information obtained by the photoelectric conversion device.

18. A method, comprising:
receiving a signal based on an avalanche count in a light receiving element;
accumulating a value corresponding to the avalanche count based on the signal; and
generating a correction value for the signal based on the accumulated value.

19. A non-transitory computer-readable storage medium storing a program for causing a computer to execute a method, the method comprising:
receiving a signal based on an avalanche count in a light receiving element;
accumulating a value corresponding to the avalanche count based on the signal; and
generating a correction value for the signal based on the accumulated value.
